(19) United States
(12) Patent Application Publication
(10) Pub. No.: US 2008/0113814 A1
(43) Pub. Date: May 15, 2008

(54) BAR-CODED PLAYER TRACKING EQUIPMENT SET UP SYSTEM AND METHOD

(75) Inventor: Lattamore D. Osburn, Las Vegas, NV (US)

Correspondence Address: MCANDREWS HELD & MALLOY, LTD, 500 WEST MADISON STREET, SUITE 3400, CHICAGO, IL, 60661, US

(73) Assignee: ARISTOCRAT TECHNOLOGIES AUSTRALIA PTY, LTD, Lane Cove (AU)

(21) Appl. No.: 11/934,280

(22) Filed: Nov. 2, 2007

Related U.S. Application Data
(60) Provisional application No. 60/857,827, filed on Nov. 10, 2006.

(51) Int. Cl. A63F 9/24; G06F 19/00

(52) U.S. Cl. 463/42; 235/375

(57) ABSTRACT

Systems and methods are provided for setting up a networked gaming system comprising a plurality of gamine devices utilizing bar-coded player tracking modules and a hand-held smart barcode scanner. According to this method, the barcode on a player tracking module can be scanned by the hand-held smart barcode scanner, additional data can then be entered into the barcode scanner and associated with the barcode stored in the barcode scanner. A central computer system is installed for controlling the plurality of gaming devices. The player tracking modules in the gaming devices are connected to the central computer system. After the central computer system is set up, the barcode and associated data stored in the barcode scanner can be downloaded to the central computer system for the central computer system to control and communicate player tracking data with the player tracking modules.

### RELATED APPLICATIONS

The present application claims priority to U.S. Provisional Patent Application No. 60/857,827 filed on Nov. 10, 2006, entitled “Bar-Coded Player Tracking Equipment Set Up Method,” which is herein incorporated by reference in its entirety.

### FEDERALLY SPONSORED RESEARCH OR DEVELOPMENT

[Not Applicable]

### FIELD OF THE INVENTION

The present invention generally relates to a method for setting up a networked gaming system in a casino that comprises a plurality of gaming devices and a central computer system. More specifically, the present invention relates to a method that enables set up of hardware peripherals in a centralized floor system in a casino before backend equipment is set up by using bar-coded player tracking modules.

### BACKGROUND OF THE INVENTION

In the casino industry, gaming machines, such as slot machines, fruit machines, or poker machines, have in recent years become one of the more popular, exciting, and sophisticated wagering activities available at casinos and other gambling locations. At the same time, gaming machines have also become a source of greater revenue for gaming establishments.

A gaming system providing entertaining and enticing features for players would be highly desirable to attract both new and returning players to a gaming establishment. To build such a gaming system, networked gaming devices have been developed in the art. Interconnecting a plurality of gaming devices such as slot machines via a computer network to a central computer system can provide many advantages. The primary advantage of networked gaming devices is the ability to extract accounting data from the individual gaming devices as well as to provide player tracking. A variety of player tracking and slot machine accounting systems have been developed in the art. To facilitate player tracking, a player tracking module (PTM) is housed in a gaming machine. The player tracking module typically includes one or more of the following peripheral devices: card reader, a keypad, a display, a bonus button, a sound device, and a biometric input device. The card reader receives a player card and reads the player information coded on the card. An example of such a player tracking module and networked gaming system is described in U.S. Pat. No. 6,162,122.

Player tracking modules are configured and set up according to the gaming machines to which they are installed. Thus, when a player inserts his/her issued player tracking card (sometimes also referred to as a player loyalty card) into the reader slot, the reader reads a code (magnetic, photo-optic, or the like) from the card and then communicates with a computer having a player tracking system in order to access the player's account information. As the player plays the gaming device, such as a slot machine, loyalty “points” are accumulated into the player's account which can be redeemed or used for various purposes including promotions, player “comps”, cash back and the like.

Besides extracting account data, preferably, the player tracking module can also provide to the central computer system player tracking information such as what game the player is playing, which gaming device the player is using, and/or where the gaming device is located on the casino floor. To do so, the central computer system must have pre-stored data reflecting the association or “marriage” of the player tracking module to the particular gaming device housing the player tracking module.

Gaming machine technicians often set up player tracking modules within gaming machines before the backend equipment is set up. Such backend equipment may include, for example, a central computer system. Also, player tracking modules may be set up before the gaming machines' information has been entered into the central computer system.

Currently, a centralized gaming system in a casino cannot be set up without the backend equipment in place. According to the current art, after the backend equipment is set up and the gaming devices are put in places on the casino floor, a casino technician will walk around the casino floor and manually write down the identification data of each player tracking module and the paired gaming device, which are needed for the central computer system to properly perform player tacking, and then enter them into the central computer system. Such identification data may include, for example, an identifier of the player tracking module, an identifier of the gaming device in which the player tracking module is installed, an identifier of the data point unit (DPU) to which the player tracking module is connected, an identifier of the Poller work station corresponding to the DPU, house number of the casino, location of the gaming machine on the casino floor, etc.

One problem with the current practice is the intensive labor and time involved for manually taking and entering the data into the central computer system after the backend equipment has been in place. A large gaming casino typically employs thousands of gaming machines that can be operated simultaneously and controlled by one or more central computer systems. For example, each OASIS™ system available from Aristocrat Technologies, Inc., Las Vegas, Nev., can handle up to 7750 active slot machines on the casino floor, up to 250 DPUs, and up to 9 Poller work stations per site. And a large casino may operate several such OASIS™ systems simultaneously. To manually take and enter the identification data of such high volume gaming devices can seriously affect the opening and operation of the casino, especially if this can only be done after the backend equipment for the gaming system has been set up and/or the gaming machines are in place on the casino floor.

Further, casino floors typically include a wide variety of electronic gaming machines, such as video slot machines, poker machines, fruit machines, reel slot machines and other gaming machines. In order to adapt to changing situations and improve slot play, slot managers often need to adjust the location and configuration of these gaming machines. Physical placement of games on the casino floor as well as manipulation of working parameters of the games on the casino floor is an important aspect of casino management.

Determining an “ideal mix” of game types, locations, denominations, and other parameters is widely regarded as an art or inexact science. A mix or configuration of games may vary from venue to venue, day to day, and/or hour to hour, for example. Thus, an ability to rapidly adjust a casino floor configuration (in whole or in part) would be highly desirable. A gaming system may change floor configuration periodically based on predefined parameters or detected play patterns on the gaming floor. Although it is now possible to virtually move games around the casino floor or change parameters within the games on the game floor from a central location without physically accessing the games, casino operators still frequently move gaming machines around the casino floors to adjust the location and configuration of these gaming machines. It is time consuming and undesirable if after every physical reconfiguration of the gaming machines, casino technicians need to manually write down and enter all the identification data for the moved gaming machines again.

Therefore, it is desirable to have a method that enables a technician to set up player tracking modules, install them in gaming machines, and electronically compile identification data associated with each player tracking module before backend equipment is set up and/or before the identification data are entered into the central computer system. It is also desirable that the electronically complied identification data can then be downloaded into a database in the central computer system when the gaming system is connected and set up.

### BRIEF SUMMARY OF THE INVENTION

The presently described technology relates to a method for setting up a networked gaming system in a casino that comprises a plurality of gaming devices and a central computer system. Such gaming devices may be gaming machines such as slot machines, fruit machines, video Poker machines, Keno or Bingo machines or any other electronic gaming device or terminal or multi-terminal gaming device. Such gaming devices may also include live table games, such as Blackjack, which may be interfaced with a player tracking and/or slot accounting system. Each of the gaming machines is equipped with a player tracking module which can be connected to the central computer system to form a player tracking and/or slot accounting system.

In one aspect, the presently described technology provides a method for setting up a networked gaming system comprising a plurality of gamine devices. In one example embodiment, the method includes the steps of:

(1) securing a unique barcode onto a player tracking module;

(2) installing the player tracking module in a gaming device;

(3) using a hand-held smart barcode scanner having a memory storage to scan the barcode secured on the player tracking module and to store the scanned barcode in the memory storage;

(4) entering additional data into the memory storage using the hand-held smart barcode scanner;

(5) associating the entered additional data with the scanned barcode;

(6) installing a central computer system for controlling the plurality of gaming devices, wherein the central computer system comprises a central memory storage;

(7) connecting the player tracking module in the gaming device with the central computer system for communication of player tracking data with the central computer system; and

(8) downloading the barcode and associated data from the memory storage of the barcode scanner to the central memory storage in the central computer system.

According to certain embodiments of this method, each of the plurality of gaming devices in the networked gaming system can be installed with a player tracking module, and each of the player tracking modules can be secured with a unique barcode for identifying the player tracking module.

It is to be understood that the steps listed above do not need to be conducted in the order as described. For example, in accordance with at least one embodiment, step (7) is performed after step (5); in accordance with at least another embodiment of the present technology, step (7) is performed before step (3).

The unique barcode for a player tracking module can be based on, for example, the Media Access Control (MAC) address of the networking equipment in the player tracking module. In one embodiment of the present technology, such networking equipment includes an Ethernet chip.

The additional data to be associated with the player tracking module may comprise, for example, one or more of the following data: the house number of the casino, the location of the casino, the location of the gaming device on the floor of the casino, and an identifier of the gaming device. In accordance with one embodiment of the present technology, at least a portion of the additional data is entered manually to the hand-held smart barcode scanner. Preferably, some of the additional data can be entered by scanning one or more different barcodes on, for example, the gaming device housing, the player tracking module or a device on the casino floor to which the gaming device is connected.

Further, the additional data can be entered into the memory storage in different times. For example, some of the additional data can be entered before the gaming device is in place on the casino floor, and some others can be entered after the gaming device is in place on the casino floor.

In accordance with at least one embodiment of the present technology, the additional data includes at least the identifier of the gaming device, which can include, for example, a serial number for the gaming device. The serial number can be assigned by the casino or by the manufacturer of the gaming device. In one embodiment, the serial number can be encoded in a barcode fixed to the gaming device, and can be scanned into the memory storage by the hand-held smart barcode scanner. Preferably, the serial number is capable of identifying at least one of following: the type of game, the model of the gaming machine, the manufacturer of the gaming machine, and the manufacturing year of the gaming machine.

### BRIEF DESCRIPTION OF THE DRAWINGS

FIG. 1 is a diagram of a casino floor having gaming machines networked to a central computer, and a bar coded player tracking module.

FIG. 2 illustrates a flow diagram for a method for configuring a networked gaming system in a casino and/or other gaming environment including a plurality of gaming devices.

FIG. 3 shows a gaming system arranged to implement a probabilistic game of the type wherein several symbols from a set of symbols are randomly displayed and a game outcome is determined on the basis of the displayed symbols.

FIG. 4 illustrates a gaming system in the form of a stand alone gaming machine.

FIG. 5 shows a block diagram of operative components of a typical gaming machine which may be the same as or different to the gaming machine shown in FIG. 4.

FIG. 6 shows a block diagram of the main components of an exemplary memory.

FIG. 7 shows a gaming system in accordance with an alternative embodiment.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EMBODIMENTS

The presently described technology relates to an improved and more convenient way to install hardware peripherals for a networked casino gaming system.

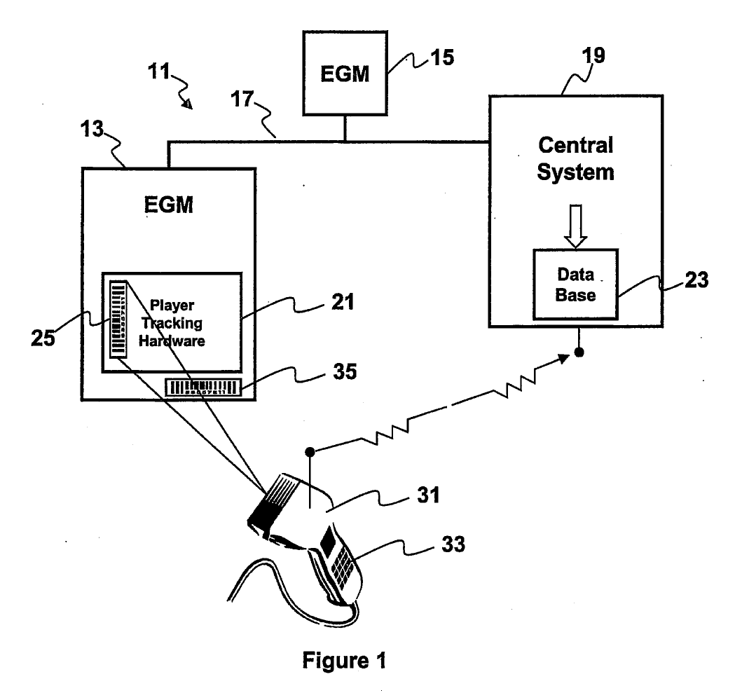

Referring to FIG. 1, a casino networked gaming system 11 includes a plurality of gaming devices 13, 15 interconnected through a network 17 to a central computer system 19. System 11, may include many other gaming devices, e.g., hundreds or thousands connected through network 17 to central computer system 19.

Each gaming device 13, 15 is equipped with a player tracking module 21 that can be connected to central computer system 19 through network 17 to form a player tracking and/or slot accounting system. Player tracking module 21 can communicate player tracking data to and from central computer system 19.

Gaming devices 13, 15 may be any electronic gaming machine (EGM) such as a slot machine, fruit machine, video Poker machine, Keno or Bingo machine, or any other electronic gaming device or terminal. Gaming devices 13, 15 may also include a live table game such as Blackjack, Pai Gow, or Baccarat, a multi-terminal gaming machine such as multi-terminal roulette, Sik Bo, Poker, dice game, and others that may be interfaced with a player tracking module and slot accounting system. As an example, a gaming table layout may be embodied as a video display. Thus gaming devices as used herein includes gaming tables as well, and are not limited to any specific kind of gaming device.

It should also be understood that the gaming system setup, to which the presently described technology can be applied, includes both the initial setup of a gaming system and the subsequent reconfiguration of the gaming system.

It should further be understood that the presently described technology is not limited to any specific kind of player tracking module or player tracking and/or slot accounting system. Any player tracking hardware, device, and system that is known in the art now or in the future can be used in combination with the method of the presently described technology. Player tracking module 21 can be connected to a central processor (not shown) or computer (not shown) in central computer system 19 which may be (1) a single processor dedicated to player tracking and/or slot accounting, (2) a shared processor, or (3) a processor separate from any player tracking and/or slot accounting computer processor. Central computer system 19 may include at least one memory storage 23 for storing data.

According to one embodiment of the presently described technology, a barcode 25 is secured onto each player tracking module 21, either before or after player tracking module 21 is installed in gaming device 13. Each barcode 25 contains a unique identifier for identifying the specific player tracking module 21 to which the barcode is secured. The barcode unique identifier for player tracking module 21 (not shown) may be based on, for example, the MAC address of the networking equipment (not shown) in the player tracking module. In one embodiment of the present technology, such networking equipment includes an Ethernet chip.

A hand-held smart barcode scanner 31 is used in conjunction with barcode 25 on player tracking module 21. Preferably, barcode scanner 31 includes at least one memory storage (not shown) to store data and, an input device 33 to input data, and a processor (not shown) to process data. Either before or during the setup of gaming system 11, a technician scans the barcode 25 using scanner 31 to identify player tracking module 21. The scanner 31 retrieves information already encoded in or associated with the barcode, and stores additional data entered by the technician via input device 33. Such additional data is associated with the barcode in the memory of the smart barcode scanner. Such additional data may include one or more of the casino's unique identifiers such as the house number, location of the casino, etc. The additional data may also include one or more of the following: a unique identifier of gaming device 13 housing the player tracking module 21, the location of the gaming device on the casino floor, e.g., area No. 1, and the location of the casino.

Preferably, the additional data include at least the unique identifier of the gaming device. In accordance with at least one embodiment of the present technology, the identifier of the gaming device can include, for example, the serial number of the gaming device. The serial number can be assigned by the casino or by the manufacturer of the gaming device. In one embodiment, the serial number can be encoded in a barcode 35 fixed to the gaming device 13, and may be scanned into the memory storage by the hand-held smart barcode scanner 31. Preferably, the serial number is capable of identifying at least one of following: the type of game, the model of the gaming machine, the manufacturer of the gaming machine, and the manufacturing year of the gaming machine.

After the central computer system for the casino gaming system is installed, the barcode 25 and associated data of each player tracking module 21 can be downloaded from the memory storage in barcode scanner 31 to memory storage 23 in central computer system 19. Preferably, barcode scanner 31 may also receive information from the central computer system. The data transfer between barcode scanner 31 and central computer system 19 may be done, for example, either via a cable or in a wireless manner.

This unique identifier of the player tracking module can be interrogated by the central computer system upon connection of the module to the system. Because of the “marriage” of the player tracking module to the particular gaming device, in accordance with at least one embodiment of the present technology, the gaming device may be moved anywhere on the network or the casino floor and be identifiable to the central computer system.

One advantage of the presently described technology is to make the manner of setting up the casino gaming system very flexible. For example, if the central computer system is already installed in the casino, the technician can connect the player tracking modules into the gaming devices and then to the network to the central computer system before scanning the player tracking modules and entering data into the barcode scanner. On the other hand, the technician(s) can scan the player tracking modules and enter at least part of the additional data into the barcode scanner and associate them with the corresponding barcodes before the player tracking modules are connected to the central computer system.

Further, the additional data can be entered into the memory storage in the barcode scanner and/or associated with a bar-coded player tracking module in different times and/or via different manners. For example, at least some of the additional data, such as the casino house number, the casino location, and the gaming device identifier can be entered and associated with the bar-coded player tracking module before the gamine device is put in place on the casino floor or even before the gamine device is shipped to the casino. This enables casino or gaming machine technician(s) to spend much less or no time on the casino floor to collect information of the player tracking modules, associating such information with the corresponding gaming machines, and entering such associated data into the central computer system, as compared to the conventional method.

In accordance with one embodiment of the present technology, at least a portion of the additional data can be entered manually to the hand-held smart barcode scanner, which is equipped with a data input device such as a keypad or a touchscreen. Preferably, some of the additional data can be entered by scanning one or more different barcodes on, for example, the gaming device housing the player tracking module or a device on the casino floor to which the gaming device is connected. In accordance with another embodiment of the present technology, some of the additional data can be obtained electronically or downloaded by the barcode scanner from a preexisting database. Such a database, for example, can be stored in the central computer system if the set-up is a reconfiguration of a preexisting gaming system. For another example, the database containing the additional data associated with unique barcodes for player tracking modules can be created by a technician when, for example, installing the player tracking modules in gamine machines and/or configuring the player tracking modules for specific casinos. The database can be stored in a server or memory storage accessible by the barcode scanner.

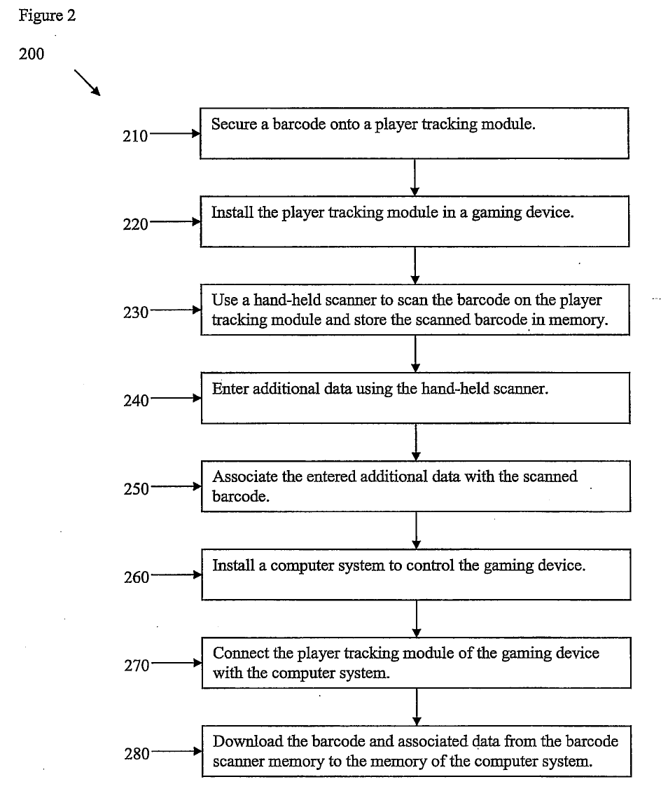

FIG. 2 illustrates a flow diagram for a method 200 for configuring a networked gaming system in a casino and/or other gaming environment including a plurality of gaming devices.

First, at step 210, a unique barcode is secured onto a player tracking module. For example, the barcode may be based on a Media Access Control (MAC) address of networking equipment, such as an Ethernet card or chip, in the player tracking module.

At step 220, the player tracking module is installed in a gaming device. In certain embodiments, each of the plurality of gaming devices is installed with a player tracking module, and each of the player tracking modules is secured with a unique barcode for identifying each of the player tracking modules.

At step 230, a hand-held smart barcode scanner having a memory storage is used to scan the barcode on the player tracking module and store the scanned barcode in the memory storage.

At step 240, additional data is entered into the memory storage using the hand-held smart barcode scanner. For example, additional data may include one or more of a house number for the casino or other gaming environment within which the gaming device is found, a location of the casino or other gaming environment, a location of the gaming device on the floor of the casino or other gaming environment, an identifier of the gaming device, etc. The identifier of the gaming device may include a serial number (e.g., a serial number assigned by a casino and/or device manufacturer), for example. The serial number may be used to identifying a game type, a gaming device and/or player tracking module model, a gaming device and/or player tracking module manufacturing year, etc. At step 250, the entered additional data is associated with the scanned barcode.

At step 260, a computer system is installed to control the plurality of gaming devices. The computer system, such as a central computer system or other server, includes a memory storage, such as a central memory storage, for example.

At step 270, the player tracking module in the gaming device is connected with the central computer system for communication of player tracking data with the central computer system. At step 280, the barcode and associated data are downloaded from the memory storage of the barcode scanner to the central memory storage in the central computer system.

One or more of the steps of the method 200 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above. For example, in an embodiment, step 270 (connecting the player tracking module in the gaming device with the remote computer system) occurs after the entered additional data is associated with the stored scanned barcode (step 250). As another example, in an embodiment, step 270 occurs before the barcode on the player tracking module is scanned and stored (step 230) such that the scanned barcode may be stored in the central computer storage memory.

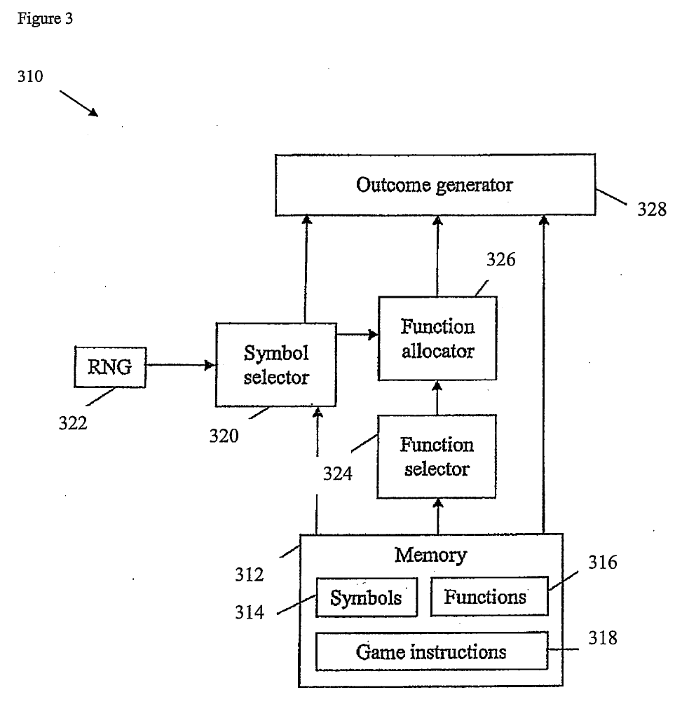

Referring to the drawings, FIG. 3 shows a gaming system 310 arranged to implement a probabilistic game of the type wherein several symbols from a set of symbols are randomly displayed and a game outcome is determined on the basis of the displayed symbols. With some such probabilistic games, the set of symbols include standard symbols at least one of which is a function symbol, and the game outcome is determined on the basis of the displayed standard symbols and the function associated with any displayed function symbol. For example, standard symbols may resemble fruit such as apples, pears and bananas with a win outcome being determined when a predetermined number of the same fruit appear on a display in the same line, scattered, and so on. The function associated with a function symbol may be for example a wild function wherein display of the function symbol is treated during consideration of the game outcome as any of the standard symbols. A function symbol may be represented as the word “WILD”, a star, or by any other suitable word or symbol. Other functions are also envisaged such as scatter functions, multiplier functions, repeat win functions, jackpot functions and feature commencement functions.

The gaming system operates such that one or more function symbols can effectively be added during a game so as to modify the probability of occurrence of a win outcome and thereby enhance player interest in playing the game. This is achieved by selecting one or more symbols to acquire a new function and determining game outcomes based on displayed symbols and the new function. The function acquired by a symbol may be in place of or in addition to any function already associated with the symbol.

Referring to FIG. 3, the gaming system 310 comprises a memory 312 arranged to store symbols data 314 indicative of a plurality of symbols for subsequent display to a player, function data 316 indicative of one or more functions allocatable to the symbols, and game instruction data 318 indicative of game instructions usable by the gaming machine 310 to control operation of the game.

The gaming system 310 also includes a symbol selector 320 which is arranged to select several symbols for display to a player and in some game circumstances to select one or more symbol to which a function is to be allocated. In this example, the selection carried out by the symbol selector 320 is made using a random number generator 322.

It will be appreciated that the random number generator 322 may be of a type which is arranged to generate pseudo random numbers based on a seed number, and that in this specification the term “random” will be understood accordingly to mean truly random or pseudo random.

The gaming system 310 also comprises a function selector 324 arranged to select one or more functions for allocation to one or more symbols selected during the special game circumstances, and a function allocator 326 arranged to allocate the or each function selected by the function selector 324 to one or more symbols selected during the special game circumstances. The function selector 324 may be arranged to randomly select a function or to select a function on the basis of a predefined rule.

The gaming system 310 also comprises an outcome generator 328 which in accordance with the game instructions 318 determines game outcomes based on the symbols selected for display to a player by the symbol selector 320, and on the basis of the function(s) allocated to one or more selected symbols, if any.

In the embodiments described below, the symbol selector 320, the function selector 324, the function allocator 326, and the outcome generator 328 are at least partly implemented using a microprocessor, although it will be understood that other implementations are envisioned.

The gaming system 310 can take a number of different forms.

In a first form, a stand alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisioned. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

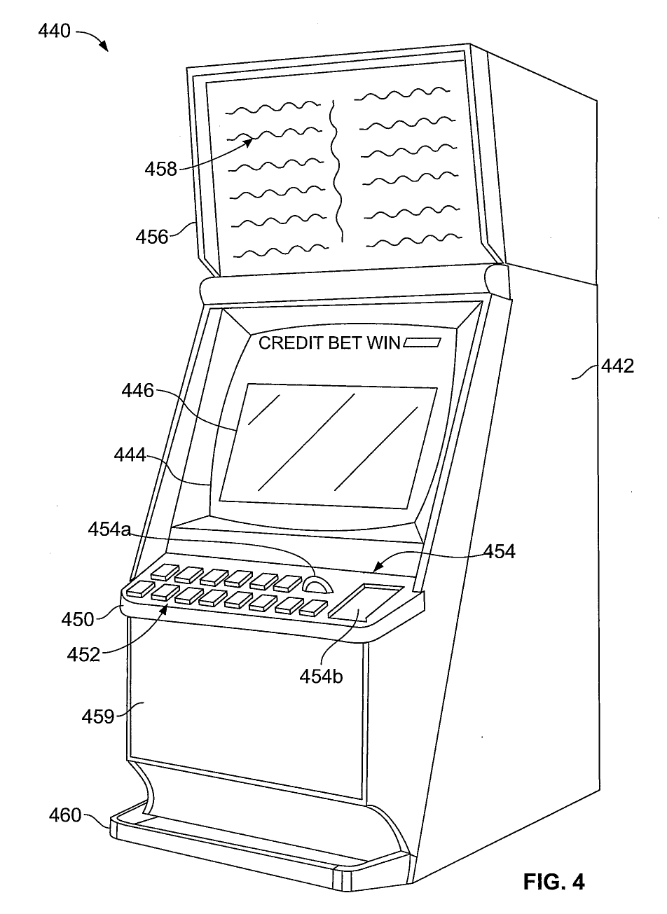

A gaming system in the form of a stand alone gaming machine 440 is illustrated in FIG. 4. The gaming machine 440 includes a console 442 having a display 444 on which is displayed representations of a game 446 that can be played by a player. A mid-trim 450 of the gaming machine 440 houses a bank of buttons 452 for enabling a player to interact with the gaming machine, in particular during gameplay. The mid-trim 450 also houses a credit input mechanism 454 which in this example includes a coin input chute 454A and a bill collector 454B. Other credit input mechanisms may also be employed, for example, a card reader for reading a smart card, debit card or credit card. A reading device may also be provided for the purpose of reading a player tracking device, for example as part of a loyalty program. The player tracking device may be in the form of a card, flash drive or any other portable storage medium capable of being read by the reading device.

A top box 456 may carry artwork 458, including for example pay tables and details of bonus awards and other information or images relating to the game. Further artwork and/or information may be provided on a front panel 459 of the console 442. A coin tray 460 is mounted beneath the front panel 459 for dispensing cash payouts from the gaming machine 440.

The display 444 is in the form of a video display unit, particularly a cathode ray tube screen device. Alternatively, the display 444 may be a liquid crystal display, plasma screen, any other suitable video display unit. The top box 456 may also include a display, for example a video display unit, which may be of the same type as the display 444, or of a different type.

The display 444 in this example is arranged to display representations of several reels, each reel of which has several associated symbols. Typically 3, 4 or 5 reels are provided. During operation of the game, the reels first appear to rotate then stop with typically three symbols visible on each reel. Game outcomes are determined on the basis of the visible symbols together with any special functions associated with the symbols.

It will be understood that instead of providing a video display unit which displays representations of reels, actual reels may be used. Such gaming machines including actual rotatable reels are commonly termed stepper machines.

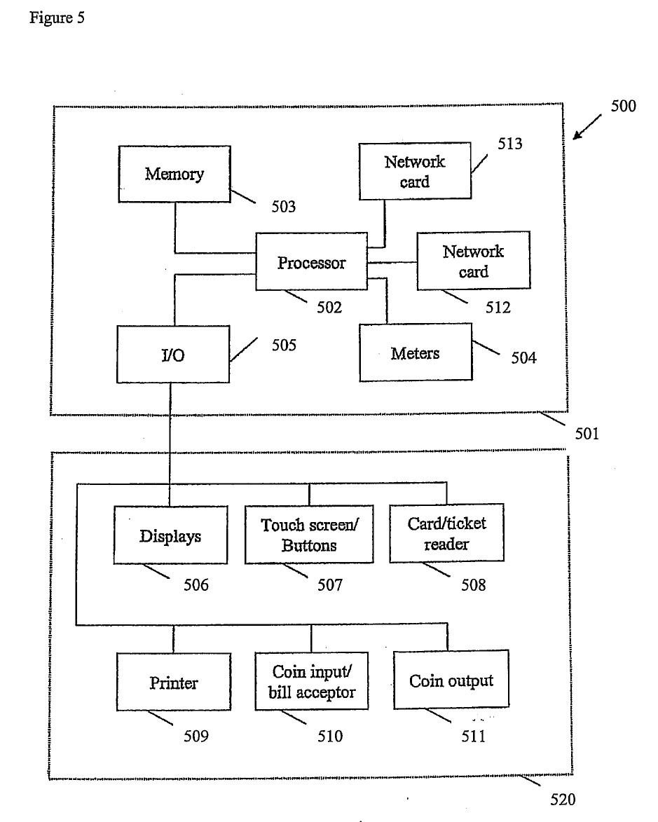

FIG. 5 shows a block diagram of operative components of a typical gaming machine 500 which may be the same as or different to the gaming machine shown in FIG. 4.

The gaming machine 500 includes a game controller 501 having a processor 502. Instructions and data to control operation of the processor 502 in accordance with the present invention are stored in a memory 503 which is in data communication with the processor 502.

Typically, the gaming machine 500 will include both volatile and non-volatile memory and more than one of each type of memory, with such memories being collectively represented by the memory 503.

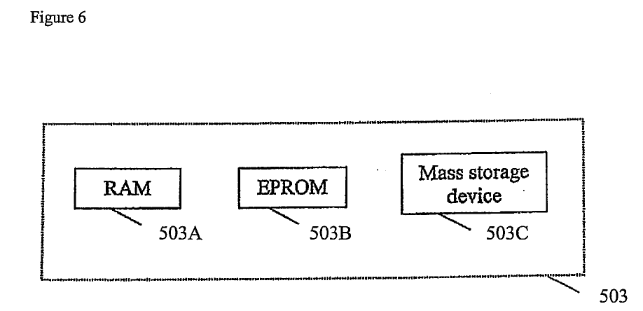

FIG. 6 shows a block diagram of the main components of an exemplary memory 503. The memory 503 includes RAM 503A, EPROM 503B and a mass storage device 503C. The RAM 503A typically temporarily holds program files for execution by the processor 502 and related data. The EPROM 503B may be a boot ROM device and/or may contain some system or game related code. The mass storage device 503C is typically used to store game programs, the integrity of which may be verified and/or authenticated by the processor 502 using protected code from the EPROM 503B or elsewhere.

The gaming machine has hardware meters 504 for purposes including ensuring regulatory compliance and monitoring player credit, an input/output (I/O) interface 505 for communicating with a player interface 520 of the gaming machine 500, the player interface 520 having several peripheral devices. The input/output interface 505 and/or the peripheral devices may be intelligent devices with their own memory for storing associated instructions and data for use with the input/output interface or the peripheral devices. A random number generator module 513 generates random numbers for use by the processor 502.

In the example shown in FIG. 5, the peripheral devices that communicate with the game controller 501 comprise one or more displays 506, a touch screen and/or bank of buttons 507, a card and/or ticket reader 508, a printer 509, a bill acceptor and/or coin input mechanism 510 and a coin output mechanism 511. Additional hardware may be included as part of the gaming machine 500, or hardware may be omitted as required for the specific implementation.

In addition, the gaming machine 500 may include a communications interface, for example a network card 512. The network card may, for example, send status information, accounting information or other information to a central controller, server or database and receive data or commands from the central controller, server or database.

It is also possible for the operative components of the gaming machine 500 to be distributed, for example input/output devices 506, 507, 508, 509, 510, 511 may be provided remotely from the game controller 501.

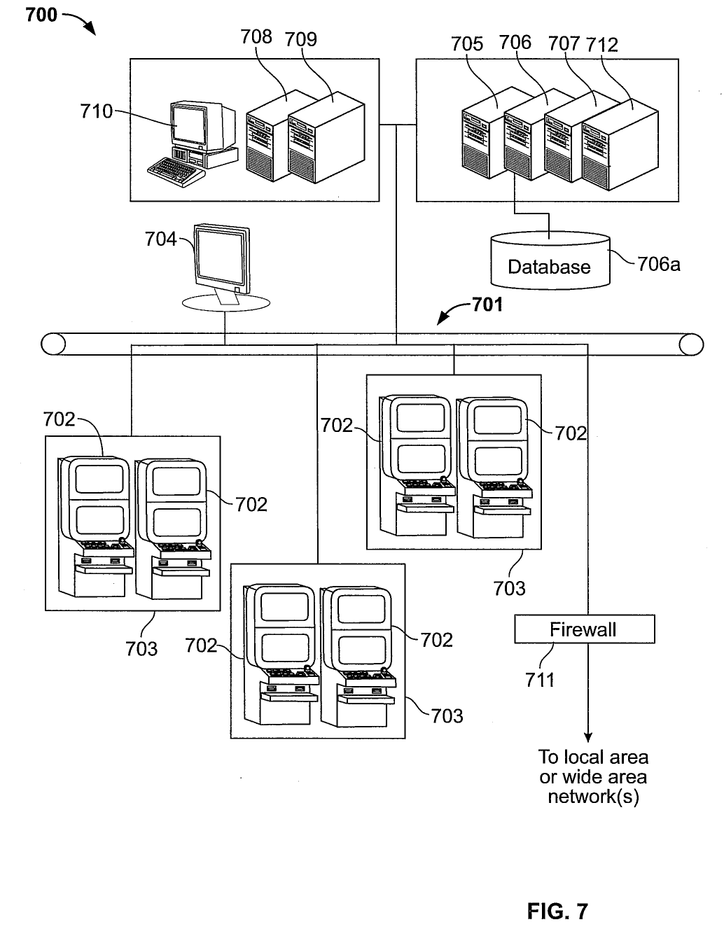

FIG. 7 shows a gaming system 700 in accordance with an alternative embodiment. The gaming system 700 includes a network 701, which for example may be an Ethernet network, a LAN or a WAN. In this example, three banks 703 of two gaming machines 702 are connected to the network 701. The gaming machines 702 provide a player operable interface and may be the same as the gaming machines 440, 500 shown in FIGS. 4 and 5, or may have simplified functionality depending on the requirements for implementing game play. While banks 703 of two gaming machines are illustrated in FIG. 7, banks of one, three or more gaming machines are also envisioned.

One or more displays 704 may also be connected to the network 701. The displays 704 may, for example, be associated with one or more banks 703 of gaming machines. The displays 704 may be used to display representations associated with game play on the gaming machines 702, and/or used to display other representations, for example promotional or informational material.

In a thick client embodiment, a game server 705 implements part of the game played by a player using a gaming machine 702 and the gaming machine 702 implements part of the game. With this embodiment, as both the game server 705 and the gaming machine 702 implement part of the game, they collectively provide a game controller. A database management server 706 may manage storage of game programs and associated data for downloading or access by the gaming devices 702 in a database 706A. Typically, if the gaming system enables players to participate in a Jackpot game, a Jackpot server 707 will be provided to monitor and carry out the Jackpot game.

In a thin client embodiment, the game server 705 implements most or all of the game played by a player using a gaming machine 702 and the gaming machine 702 essentially provides only the player interface. With this embodiment, the game server 705 provides the game controller. The gaming machine will receive player instructions, and pass the instructions to the game server which will process them and return game play outcomes to the gaming machine for display. In a thin client embodiment, the gaming machines could be computer terminals, e.g. PCs running software that provides a player interface operable using standard computer input and output components.

Servers may also be provided to assist in the administration of the gaming system 700, including for example a gaming floor management server 708 and a licensing server 709 to monitor the use of licenses relating to particular games. An administrator terminal 710 is provided to allow an administrator to monitor the network 701 and the devices connected to the network.

The gaming system 700 may communicate with other gaming systems, other local networks such as a corporate network, and/or a wide area network such as the Internet, for example through a firewall 711.

Persons skilled in the art will appreciate that in accordance with known techniques, functionality at the server side of the network may be distributed over a plurality of different computers. For example, elements may be run as a single “engine” on one server or a separate server may be provided. For example, the game server 705 could run a random number generator engine. Alternatively, a separate random number generator server could be provided.

The components, elements, and/or functionality of the system(s) described above may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, certain embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Certain embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Certain embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of certain embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of a variety of gaming systems. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

While certain embodiments of the present invention have been described, it should be understood that these embodiments are subject to many modifications and changes without departing from the spirit and scope of the appended claims. For example, it will be understood that the invention disclosed and defined in this specification extends to all alternative combinations of two or more of the individual features mentioned or evident from the text or drawings. All of these different combinations constitute various alternative aspects of the invention. It will also be understood that the term “comprises” (or its grammatical variants) as used in this specification is equivalent to the term “includes” and should not be taken as excluding the presence of other elements or features.

What is claimed is:

1. A method for setting up a networked gaming system in a casino that comprises a plurality of gaming devices, comprising the steps of:
(1) securing a unique barcode onto a player tracking module;
(2) installing the player tracking module in a gaming device;
(3) using a hand-held smart barcode scanner having a memory storage to scan the barcode on the player tracking module and store the scanned barcode in the memory storage;
(4) entering additional data into the memory storage using the hand-held smart barcode scanner;
(5) associating the entered additional data with the scanned barcode;
(6) installing a central computer system for controlling the plurality of gaming devices, wherein the central computer system comprises a central memory storage;
(7) connecting the player tracking module in the gaming device with the central computer system for communication of player tracking data with the central computer system; and
(8) downloading the barcode and associated data from the memory storage of the barcode scanner to the central memory storage in the central computer system.

2. The method of claim 1, wherein each of the plurality of gaming devices is installed with a player tracking module, and each of the player tracking module is secured with a unique barcode for identifying the player tracking module.

3. The method of claim 1, wherein step (7) is performed after step (5).

4. The method claim 1, wherein step (7) is performed before step (3).

5. The method of claim 1, wherein the barcode is based on the Media Access Control address of the networking equipment of the player tracking module.

6. The method of claim 5, wherein the networking equipment comprises an Ethernet chip.

7. The method of claim 1, wherein the additional data comprises one or more of the house number of the casino, the location of the casino, the location of the gaming device on the floor of the casino, and an identifier of the gaming device.

8. The method of claim 7, wherein the additional data comprises the identifier of the gaming device.

9. The method of claim 7, wherein the identifier of the gaming device comprises a serial number.

10. The method of claim 9, wherein the serial number is assigned by the casino.

11. The method of claim 9, wherein the serial number is assigned by the manufacturer of the gaming device.

12. The method of claim 9, wherein the serial number is capable of identifying at least one of the type of game, the model, and the manufacturing year of the gaming machine.

13. The method of claim 1, wherein said step of entering additional data further comprises entering additional data into the memory storage using the hand-held smart barcode scanner by scanning the additional data.

14. The method of claim 1, wherein said step of entering additional data further comprises entering additional data into the memory storage using the hand-held smart barcode scanner by manually entering the additional data via an input 10 device on the hand-held smart barcode scanner.

15. A networked gaming system comprising:
a plurality of gaming devices;
a plurality of player tracking modules, each of said player tracking modules including a barcode secured to the player tracking module to identify the player tracking module, each of the player tracking modules adapted for installation into a gaming device;
a hand-held barcode scanner having a memory storage to scan the barcode on the player tracking module and store the scanned barcode in the memory storage, said barcode scanner adapted for additional data entry into the memory storage in association with the scanned barcode data; and
a central computer system for controlling the plurality of gaming devices, the central computer system including a central memory storage, the central computer system in communication with the player tracking module in the gaming device to receive player tracking data, wherein the barcode and associated data are transferred from the memory storage of the barcode scanner to the central memory storage in the central computer system.

16. The system of claim 15, wherein each of the plurality of gaming devices is secured with a barcode for identifying the gaming device.

17. The system of claim 15, wherein the barcode is based on the Media Access Control address of networking equipment of the player tracking module.

18. The system of claim 15, wherein the additional data comprises one or more of the house number of the casino, the location of the casino, the location of the gaming device on the floor of the casino, and an identifier of the gaming device.

19. The system of claim 18, wherein the identifier of the gaming device comprises a serial number.

20. A player tracking system comprising a player tracking module adapted for installation into a gaming device, the player tracking module including a barcode secured to the player tracking module to identify the player tracking module, the barcode scannable to provide identification information for the player tracking module to a remote computer.

21. The system of claim 20, further comprising a gaming device including the player tracking module, wherein the gaming device includes a barcode scannable to provide identification information for the gaming device to a remote computer.
